(19) United States
(12) Patent Application Publication
(10) Pub. No.: US 2026/0253830 A1
(43) Pub. Date: Aug. 27, 2026

(54) SYSTEM AND METHOD FOR CATHODE CONTROLLED ANODE IMPACT TEMPERATURE

(71) Applicant: GE Precision Healthcare LLC, Waukesha, WI (US)

(72) Inventors: Vinoth Kumar Lakshmi Narayanan, Bangalore (IN); Sergio Lemaitre, Whitefish Bay, WI (US); Naren Balathandayutham, Bangalore (IN); Rahul Kurup, Bangalore (IN)

(21) Appl. No.: 19/061,102

(22) Filed: Feb. 24, 2025

(51) Int. Cl. H01J 35/06; H01J 35/10

(52) U.S. Cl. CPC H01J 35/066; H01J 35/064; H01J 35/065; H01J 35/10

(57) ABSTRACT

An X-ray tube includes an anode configured to rotate during operation of the X-ray tube. The X-ray tube also includes a cathode assembly. The cathode assembly includes a filament emitter configured to emit electrons when heated. The cathode assembly also includes a cathode cup configured to focus the electrons emitted form a focal spot on an annular target track on the anode, wherein the cathode cup includes a channel that the filament emitter is disposed within, and wherein the channel has a geometry configured to enable selective radiation to escape from the cathode cup to control a temperature profile of the filament emitter to alter a length profile of the focal spot to reduce a target impact temperature on the annular target track within the focal spot without altering a size of the focal spot.

### BACKGROUND

The subject matter disclosed herein relates to X-ray tubes, and, more specifically, to a system and method for cathode controlled anode impact temperature.

Non-invasive imaging technologies allow images of the internal structures or features of a subject (patient, manufactured good, baggage, package, or passenger) to be obtained non-invasively. In particular, such non-invasive imaging technologies rely on various physical principles, such as the differential transmission of X-rays through the target volume, to acquire data and to construct images or otherwise represent the internal features of the subject.

In such X-ray based non-invasive imaging contexts, X-ray tubes are typically used to generate the X-rays passed through the subject. Examples of imaging systems employing X-ray tubes include, but are not limited to systems for: radiography, mammography, tomosynthesis, C-arm angiography, fluoroscopy, and computed tomography (CT) systems, as well as others. The X-rays emitted by X-ray tubes in such systems are generated in response to control signals during an examination or imaging sequence.

Typically, the X-ray tube includes a cathode and an anode. An emitter within the cathode may emit a stream of electrons in response to heat resulting from an applied electrical current, and/or an electric field resulting from an applied voltage. The anode may include a target that is impacted by the stream of electrons. The target may, as a result of impact by the electron beam, produce X-ray radiation to be emitted toward an imaged volume.

X-ray tubes, while operating with small spots (for better spatial resolution), carry risk of high target loading. This results in high impact temperatures, leading to damaging the target. Therefore, X-ray tubes are constrained to produce focal spots that are close to the upper specification limit to have acceptable image quality requirements. This constraint ends up decreasing the yield of X-ray tubes.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an X-ray tube is provided. The X-ray tube includes an anode configured to rotate during operation of the X-ray tube. The X-ray tube also includes a cathode assembly. The cathode assembly includes a filament emitter configured to emit electrons when heated. The cathode assembly also includes a cathode cup configured to focus the electrons emitted form a focal spot on an annular target track on the anode during rotation of the anode, wherein the cathode cup includes a channel that the filament emitter is disposed within, and wherein the channel has a geometry configured to enable selective radiation to escape from the cathode cup to control a temperature profile of the filament emitter to alter a length profile of the focal spot to reduce a target impact temperature on the annular target track within the focal spot without altering a size of the focal spot.

In another embodiment, an X-ray imaging system is provided. The X-ray imaging system includes an X-ray tube configured to emit X-rays. The X-ray tube includes an anode configured to rotate during operation of the X-ray tube. The X-ray tube includes an anode configured to rotate during operation of the X-ray tube. The X-ray tube also includes a cathode assembly. The cathode assembly includes a filament emitter configured to emit electrons when heated. The cathode assembly also includes a cathode cup configured to focus the electrons emitted form a focal spot on an annular target track on the anode during rotation of the anode, wherein the cathode cup includes a channel that the filament emitter is disposed within, and wherein the channel has a geometry configured to enable selective radiation to escape from the cathode cup to control a temperature profile of the filament emitter to alter a length profile of the focal spot to reduce a target impact temperature on the annular target track within the focal spot without altering a size of the focal spot. The X-ray imaging system also includes an X-ray detector facing the X-ray tube and configured to generate signals in response to X-rays incident on the X-ray detector.

In accordance with a further embodiment, a cathode cup of an X-ray tube configured to focus electrons emitted from a filament emitter, when heated, to form a focal spot on an annular target track on an anode during rotation of the anode is provided. The cathode cup includes a body. The cathode cup also includes a channel formed within the body, wherein the channel is configured to receive the filament emitter within, and wherein the channel includes at least one hole configured to enable selective radiation to escape from the cathode cup to control a temperature profile of the filament emitter to alter a length profile of the focal spot to reduce a target impact temperature on the annular target track within the focal spot without altering a size of the focal spot.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a diagrammatical overview of a digital X-ray imaging system in which the present technique may be utilized;

FIG. 2 is a diagrammatical illustration of an embodiment of an X-ray tube having a cathode cup that enables cathode controlled anode impact temperature, in accordance with the present disclosure;

FIGS. 3A-3C depict a table illustrating control emitter temperature profiles to shape an electron beam and associated relative power capability, in accordance with aspects of the present disclosure;

FIG. 4 depicts a top view a cathode cup with a single coil filament emitter having a single straight through hole in a channel, in accordance with aspect of the present disclosure;

FIG. 5 depicts a side cross-sectional view of the cathode cup with the single coil filament emitter in FIG. 4, taken along line 5-5, in accordance with aspects of the present disclosure;

FIG. 6 depicts a top view a cathode cup with a single coil filament emitter having a single funnel-like through hole in a channel, in accordance with aspect of the present disclosure;

FIG. 7 depicts a side cross-sectional view of the cathode cup with the single coil filament emitter in FIG. 6, taken along line 7-7, in accordance with aspects of the present disclosure;

FIG. 8 depicts a top view a cathode cup with a single coil filament emitter having a single straight closed hole in a channel, in accordance with aspect of the present disclosure;

FIG. 9 depicts a side cross-sectional view of the cathode cup with the single coil filament emitter in FIG. 8, taken along line 9-9, in accordance with aspects of the present disclosure;

FIG. 10 depicts a side cross-sectional view of a cathode cup with a single coil filament emitter having a concave recess in a bottom surface of a channel, in accordance with aspects of the present disclosure;

FIG. 11 depicts a side cross-sectional view of a cathode cup with a single coil filament emitter having a ramp-like recess in a bottom surface of a channel, in accordance with aspects of the present disclosure;

FIG. 12 is a schematic top view of a channel of a cathode cup having a hole with triangular shape, in accordance with aspects of the present disclosure;

FIG. 13 is a schematic top view of a channel of a cathode cup having a hole with square shape, in accordance with aspects of the present disclosure;

FIG. 14 is a schematic top view of a channel of a cathode cup having a hole with star shape, in accordance with aspects of the present disclosure;

FIG. 15 depicts a graph of thermo-electric simulation results of cathode cups with different geometries, in accordance with aspects of the present disclosure;

FIG. 16 is a schematic diagram of cathode cups with different geometries that utilize flat filament emitters and associated simulated focal spot length profiles, in accordance with aspects of the present disclosure;

FIG. 17 depicts a measured focal spot length profile for a cathode cup having a single hole in the channel, in accordance with aspects of the present disclosure;

FIG. 18 depicts a measured focal spot length profile for a cathode cup lacking a hole in the channel, in accordance with aspects of the present disclosure;

FIG. 19 depicts a graph of a temperature profile of a flat coil emitter of a cathode cup having a single hole in the channel comparing measured and simulated measurements, in accordance with aspects of the present disclosure; and

FIG. 20 depicts a table for the calculation of the normalized loading temperature, in accordance with aspects of the present disclosure.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the following discussion is generally provided in the context of medical imaging, it should be appreciated that the present techniques are not limited to such medical contexts. Indeed, the provision of examples and explanations in such a medical context is only to facilitate explanation by providing instances of real-world implementations and applications. However, the present approaches may also be utilized with respect to X-ray tubes in other contexts, such as X-ray tubes used in the non-destructive inspection of manufactured parts or goods (i.e., quality control or quality review applications), and/or the non-invasive inspection of packages, boxes, luggage, and so forth (i.e., security or screening applications). In general, the present approach may be desirable in any imaging or screening context in which an X-ray tube is utilized.

The present disclosure provides systems and methods for cathode controlled anode impact temperature. In particular, a modified geometry in a channel of a cathode cup (e.g., cathode focusing cup) enables a reduction in target impact temperature (i.e., temperature of a target track within a focal spot resulting from impacting electrons of the electron beam) without comprising spatial resolution, enhancing the defect margin and thereby improving the yield of the X-ray tubes. When the impact temperature is minimized, without altering the focal spot size, the modified geometry can be leveraged to run the X-ray tube with smaller focal spots. Alternatively, the modified geometry can be leveraged to operate the X-ray tubes at higher powers. Without any change in the initial calibration verification, the disclosed embodiments improve the manufacturing yield of the X-ray tubes, provide higher X-ray tube power capability, improve spatial resolution, and improve cost of reworking (e.g., labor hours, scrap, overheads, etc.).

The disclosed embodiments include an X-ray tube including an anode configured to rotate during operation of the X-ray tube. The X-ray tube also includes an anode configured to rotate during operation of the X-ray tube. The X-ray tube also includes a cathode assembly. The cathode assembly includes a filament emitter configured to emit electrons when heated. The cathode assembly also includes a cathode cup configured to focus the electrons emitted form a focal spot on an annular target track on the anode during rotation of the anode, wherein the cathode cup includes a channel that the filament emitter is disposed within, and wherein the channel has a geometry (e.g., modified geometry) configured to enable selective radiation to escape from the cathode cup to control a temperature profile of the filament emitter to alter a length profile of the focal spot (without compromising the focal spot size) to reduce a target impact temperature on the annular target track within the focal spot without altering a size of the focal spot.

In certain embodiments, the channel includes at least one hole. In certain embodiments, the at least one hole includes a through hole. In certain embodiments, the at least one hole includes a closed hole. In certain embodiments, the at least one hole varies in a diameter along a depth of the at least one hole. In certain embodiments, the at least one hole has a consistent diameter along a depth of the at least one hole. In certain embodiments, the channel includes a plurality of holes (e.g., through holes, closed holes, or a combination thereof). In certain embodiments, wherein the geometry of the channel has a curved boat-like shape. In certain embodiments, the geometry of the channel has funnel shape or other shape. In certain embodiments, the modified geometry of the channel affecting the impact temperature is utilized in conjunction with moving tabs closer (which focuses the electron beam and reduces the focal spot length).

In certain embodiments, the filament emitter includes a coil filament. In certain embodiments, the filament emitter includes a flat filament. In certain embodiments, the cathode assembly includes: a first filament emitter; and a second filament emitter; and the cathode cup includes a first channel that the first filament emitter is disposed within and a second channel that the second filament emitter is disposed within, and at least one of either the first channel or the second channel has the geometry configured to enable selective radiation to escape from the cathode cup to control the temperature profile of a respective filament emitter to alter the length profile of the focal spot (without compromising the focal spot size) to reduce the target impact temperature on the annular target track within the focal spot without altering the size of the focal spot. In certain embodiments, both the first channel and the second channel has a respective geometry configured to enable selective radiation to escape from the cathode cup to control a respective temperature profile of the first filament emitter and the second filament emitter, respectively, to alter a respective length profile of a respective focal spot (without compromising the focal spot size) to reduce the target impact temperature on the annular target track within the respective focal spot without altering the size of the respective focal spot. In certain embodiments, the first channel and the second channel each comprise a hole.

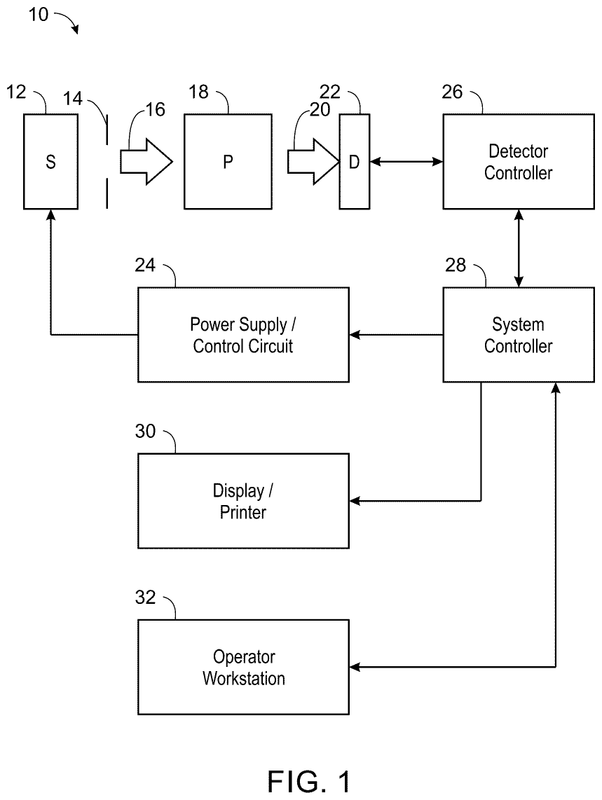

Turning now to the drawings, FIG. 1 illustrates diagrammatically an imaging system 10 for acquiring and processing discrete pixel image data. In the illustrated embodiment, system 10 is a digital X-ray system designed both to acquire original image data and to process the image data for display. The imaging system 10 may be a stationary system disposed in a fixed X-ray imaging room or a mobile X-ray system. In the embodiment illustrated in FIG. 1, imaging system 10 includes a source of X-ray radiation 12 (e.g., one or more X-ray tubes) positioned adjacent to a collimator 14. Collimator 14 permits a stream of radiation 16 to pass into a region in which a subject 18, such as a human patient is positioned. A portion of the radiation 20 passes through or around the subject and impacts a digital X-ray detector, represented generally at reference numeral 22. The detector 22 may be portable or permanently mounted to the system 10. In certain embodiments, the detector 22 may convert the X-ray photons incident on its surface to lower energy photons, and subsequently to electric signals, which are acquired and processed to reconstruct an image of the features within the subject. In other embodiments, such as in a direct conversion implementation, the incident radiation itself may be measured without an intermediary conversion process.

Source 12 is controlled by a power supply/control circuit 24 which furnishes both power and control signals for examination sequences. Moreover, detector 22 is coupled to a detector controller 26 which commands acquisition of the signals generated in the detector 22. Detector controller 26 may also execute various signal processing and filtration functions, such as for initial adjustment of dynamic ranges, interleaving of digital image data, and so forth. Both power supply/control circuit 24 and detector controller 26 are responsive to signals from a system controller 28. In general, system controller 28 commands operation of the imaging system to execute examination protocols and to process acquired image data. In the present context, system controller 28 also includes signal processing circuitry, typically based upon a general purpose or application-specific digital computer; and associated manufactures, such as optical memory devices, magnetic memory devices, or solid-state memory devices, for storing programs and routines executed by a processor of the computer to carry out various functionalities, as well as for storing configuration parameters and image data; interface protocols; and so forth. In one embodiment, a general or special purpose computer system may be provided with hardware, circuitry, firmware, and/or software for performing the functions attributed to one or more of the power supply/control circuit 24, the detector controller 26, and/or the system controller 28 as discussed herein.

In the embodiment illustrated in FIG. 1, system controller 28 is linked to at least one output device, such as a display or printer as indicated at reference numeral 30. The output device may include standard or special purpose computer monitors and associated processing circuitry. One or more operator workstations 32 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

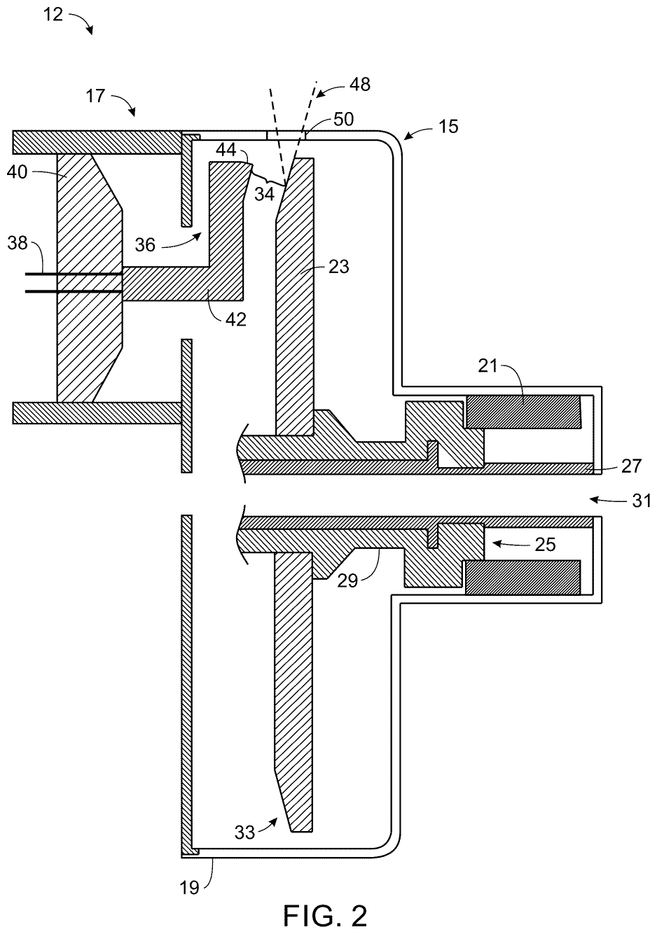

FIG. 2 illustrates an embodiment of an X-ray tube 12 having a cathode cup that enables cathode controlled anode impact temperature. In the illustrated embodiment, the X-ray tube 12 includes an anode assembly 15 and a cathode assembly 17. The X-ray tube 12 is supported by the anode and cathode assemblies 15, 17 within an envelope 18 defining an area of relatively low pressure (e.g., a vacuum) compared to ambient, in which high voltages may be present. The envelope 18 may be within a casing (not shown) that is filled with a cooling medium, such as oil, that surrounds the envelope 19. The cooling medium may also provide high voltage insulation.

The anode assembly 15 generally includes a rotor 21 and a stator outside of the X-ray tube 12 (not shown) at least partially surrounding the rotor 21 for causing rotation of an anode 23 during operation. The anode 23 is supported in rotation by a bearing 25, which, when rotated, also causes the anode 23 to rotate. The anode 23 has an annular shape, such as a disc, and an annular opening in the center thereof for receiving the bearing 25. In general, the bearing 25 includes a stationary portion, such as a shaft 27 and a rotary portion, such as a bearing sleeve 29 to which the anode 23 is attached. While the shaft 27 is presently described in the context of a stationary shaft, it should be noted that the present approaches are also applicable to embodiments wherein the shaft 27 is a rotary shaft. In such a configuration, it should be noted that the X-ray target would rotate as the shaft rotates. In certain embodiments, the bearing 25 maybe a journal bearing, a ball bearing, or a spiral groove bearing. Keeping the foregoing in mind, in one embodiment, the bearing 25 may have a liquid metal lubricant disposed between the bearing sleeve 29 and the shaft 27. The shaft 27 may optionally include a coolant flow path 31 through which a coolant, such as oil, may flow so as to cool the bearing 25. In the illustrated embodiment, the coolant flow path 31 extends along a longitudinal length of the X-ray tube 12, which is depicted as a straddle configuration. However, it should be noted that in other embodiments, the coolant flow path 31 may extend through only a portion of the X-ray tube 12, such as in configurations where the X-ray tube 12 is cantilevered when placed in an imaging system.

During operation, rotation of the bearing 25 advantageously allows a front portion of the anode 23, which has a target or focal surface 33 (e.g., forming annular target track during rotation of anode 23) formed thereon, to be periodically struck by an electron beam 34, rather than continuously. Such periodic bombardment may allow the resulting thermal energy to be dispersed, rather than concentrated, which may result in one or more anode failure modes (e.g., cracking, deformation, rupture). Generally, the anode 23 may be rotated at a high speed (e.g., 100 to 200 Hz). The anode 23 may be manufactured to include a number of metals or composites, such as tungsten, molybdenum, copper, or any material that contributes to Bremsstrahlung (i.e., deceleration radiation) when bombarded with electrons. The anode's surface material is typically selected to have a relatively high refractory value so as to withstand the heat generated by electrons impacting the anode 23. Further, the space between the cathode assembly 17 and the anode 23 may be evacuated in order to minimize electron collisions with other atoms and to maximize an electric potential. In some X-ray tubes, voltages in excess of 160 kV are created between the cathode assembly 17 and the anode 23, causing electrons emitted by the cathode assembly 17 to become attracted to the anode 23.

The electron beam 34 is produced by the cathode assembly 17 and, more specifically, a cathode 36 that receives one or more electrical signals via a series of electrical leads 38. The electrical signals may be timing/control signals that cause the cathode 36 to emit the electron beam 34 at one or more energies and at one or more frequencies. Further, the electrical signals may at least partially control the potential between the cathode 36 and the anode 23. The cathode 36 includes a central insulating shell 40 from which a mask 42 extends. The mask 42 encloses the leads 38, which extend to a cathode cup 44 (e.g., cathode focusing cup) mounted at the end of the mask 42. In some embodiments, the cathode cup 44 serves as an electrostatic lens that focuses electrons emitted from an emitter (e.g., filament emitter such as a thermionic filament) within the cup 44 to form the electron beam 34. The cathode cup 44 is made of metal (e.g., nickel) and is negatively charged. The negative charge of the focusing cup helps to accelerate the electrons toward the anode 23. The shape of the focusing cup helps to converge the electrons on the focal spot. The cathode assembly 17 may include one or more emitters disposed within respective channels (e.g., receptacles) on a surface of the cathode cup 44 that is open and faces the anode 23. In certain embodiments, the one or more emitters are coil filaments. In certain embodiments, the one or more emitters are flat filaments.

As control signals are conveyed to cathode 36 via leads 38, the emitter within cup 44 is heated and produces the electron beam 34. The beam 34 strikes the focal surface 33 of the anode 23 and generates X-ray radiation 48, which is diverted out of an X-ray aperture 50 of the X-ray tube 12. The direction and orientation of the X-ray radiation 48 may be controlled by a magnetic field produced outside of the X-ray tube 12, or through electrostatic means at the cathode 36, and the like. The field produced may generally shape the X-ray radiation 48 into a focused beam, such as a cone-shaped beam as illustrated. The X-ray radiation 48 exits the tube 12 and is generally directed towards a subject of interest during examination procedures.

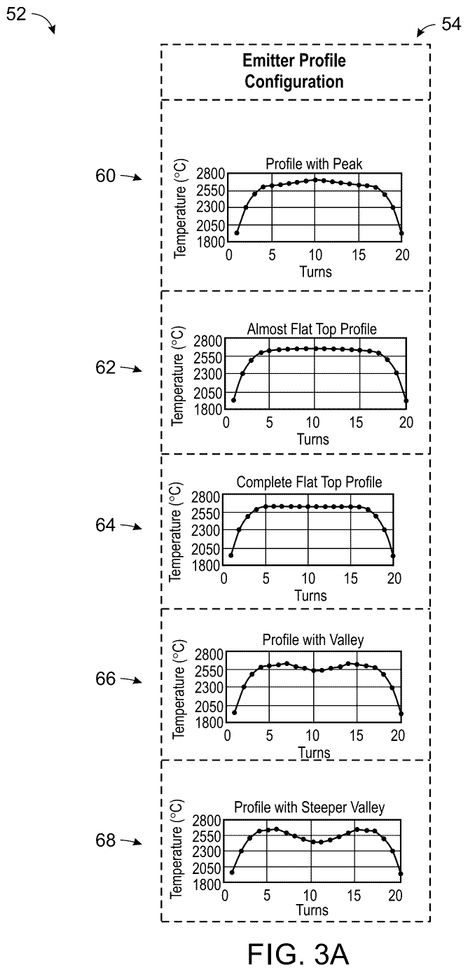

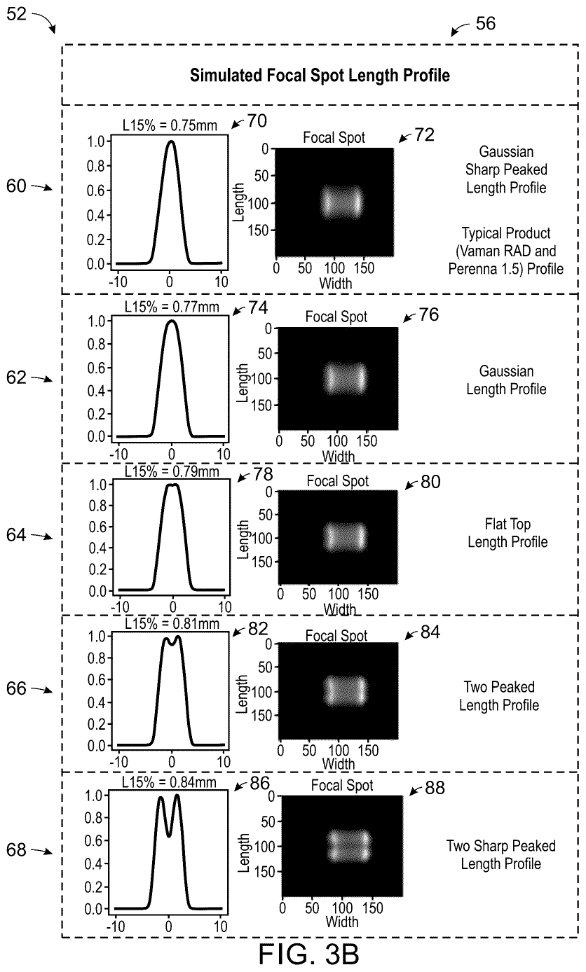

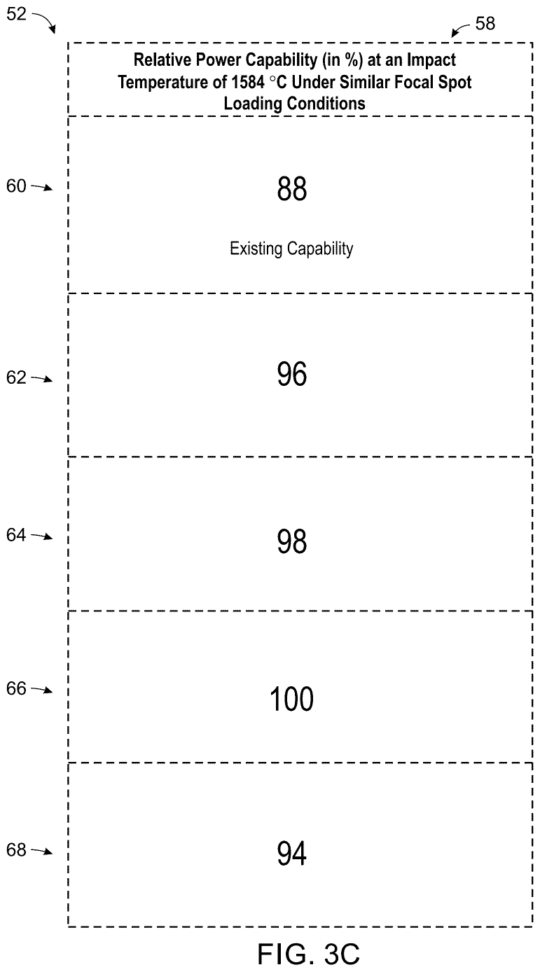

FIGS. 3A-3C depict a table 52 illustrating control emitter temperature profiles to shape an electron beam and associated relative power capability. The focal spot impact temperature does not depend only on the focal spot size but also on the focal spot profiles. The focal spot length profile, which has a greater impact on the target loading, is reshaped by modifying the emitter temperature profiles. Electron optics simulation results are shown in the table 52.

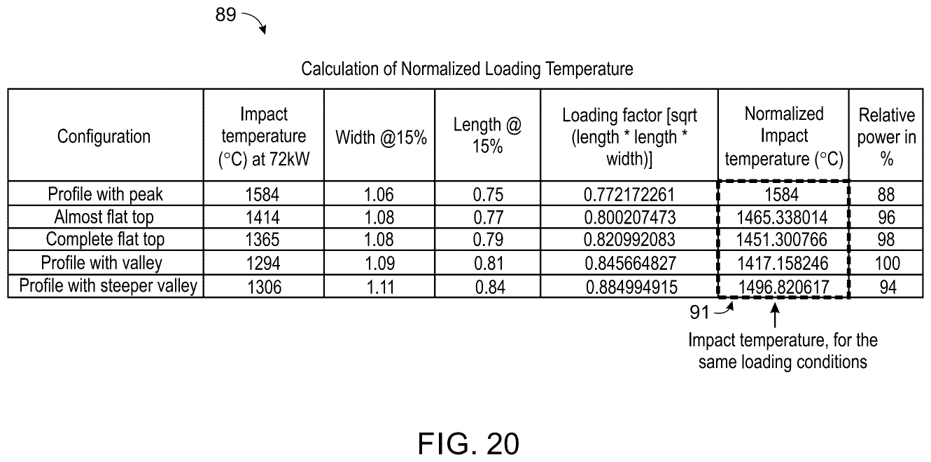

The table 52 includes a first column 54 for emitter profile configurations, a second column 56 for simulated focal spot length profile, and a third column 58 for relative power capability. Each corresponding row in the table 52 (in the respective columns 54, 56, and 58) relates to a respective emitter profile configuration. It should be that the focal spot dimensioning (i.e., length and width) of the focal spot is generally considered at 15 percent of its maximum intensity (e.g., as applied to the plots in graphs 70, 74, 78, 82, and 86. The dimensions for the different emitter profile configurations are shown in table 89 in FIG. 20. The first column 54 includes graphs depicting different emitter profile configurations where each graph includes a y-axis representing temperature and an x-axis representing turns of a filament emitter. Graph 60 depicts an emitter profile with a peak. Graph 62 depicts an almost flat top emitter profile. Graph 64 depicts a complete flat top emitter profile. Graph 66 depicts an emitter profile with a valley. Graph 68 depicts an emitter profile with sleeper valley (relative to the valley in graph 66).

The second column 56 includes graphs depicting a size and normalized intensity of a respective focal spot for each emitter profile and a corresponding image of the focal spot. Each graph in the second column 56 includes a y-axis representing normalized intensity and an x-axis representing size of a focal spot. Each image of the focal spots in the second column includes an x-axis representing length and a y-axis representing width. Graph 70 depicts the simulated focal length profile generated with the emitter profile with the peak and image 72 depicts the corresponding focal spot. Graph 70 and image 72 depicts a Gaussian sharp peaked length profile (a typical focal spot length profile). Graph 74 depicts the simulated focal length profile generated with the almost flat top emitter profile and image 76 depicts the corresponding focal spot. Graph 74 and image 76 depicts a Gaussian length profile. Graph 78 depicts the simulated focal length profile generated with the complete flat top emitter profile and image 80 depicts the corresponding focal spot. Graph 78 and image 80 depicts a flat top length profile. The flat top length profile means the focused electrons are distributed in a larger area, which brings down the impact temperature at the target. Graph 82 depicts the simulated focal length profile generated with the emitter profile with a valley and image 84 depicts the corresponding focal spot. Graph 82 and image 84 depicts a two peaked length profile. Graph 86 depicts the simulated focal length profile generated with the emitter profile with a steeper valley and image 88 depicts the corresponding focal spot. Graph 86 and image 88 depicts a two sharp peaked length profile.

Currently, the existing X-ray tubes are not able to be utilized with maximum power capability due to high thermal loads on the target. Under the same loading conditions and same impact temperature at the target, the power capability of the X-ray tube can be enhanced by shaping the focal spot length profile, with appropriate emitter temperature profiles, to enhance the power capability. The table shows the reduction in impact temperature, under similar loading conditions. For the same impact temperature (1584° C.), the tube power can be enhanced by approximately 12 percent as shown in third column 58 of the table 52. In the third column 58 of the table 52, the emitter profile with a peak has a relative power capability of 88 percent (which is the existing capability), the profile with almost flat top emitter profile has a relative power capability of 96 percent, the complete flat top emitter profile has a relative power capability 98 percent, the emitter profile with valley has a relative power capability of 100 percent, and emitter profile with steeper valley has a relative power capability of 94 percent.

The calculation of the normalized loading temperature for the different emitter profile configurations in table 52 is depicted in table 89 in FIG. 20. Column 91 of the table 89 depicts the normalized impact temperature for the same loading conditions. Since the impacts are normalized with respect to the loading factor, the temperature, the temperature variations are only due to the focal spot shape (profile) and not the focal spot size.

The temperature profile of the filament emitter is a function of cathode cup geometry and the cup material. The radiation reflected from the cathode cup (e.g., from underneath the cathode cup and from the channel sides of a channel or receptacle within the body of the cup that the filament emitter is disposed within) contributes to the filament temperature. By modifying the radiation received back from the cathode cup (via reflection), the emitter temperature profiles can be controlled. Therefore, modification (e.g., removal of material) of the cathode cup geometry to enable selective escape (e.g., for specific turns or regions of the filament emitter) of radiation from the cathode cup and away from the filament emitter can be an effective way to alter the emitter temperature distribution. The emitter temperature distribution (across the filament emitter) can be fine-tuned by altering the geometry of the respective channel within a body of the cathode cup that the respective filament emitter is disposed within. For example, one or more holes may be introduced into one or more channels of the cathode cup. The holes may vary in hole size, hole depth, and hole shape. The holes may be through holes that completely pass through the body of the cathode cup from the bottom surface of the channel (which interfaces with the filament emitter) to a backside of cathode cup (opposite the bottom surface of the channel). The holes may be closed holes that only partially pass through the body of the cathode cup from the bottom surface of the channel toward the backside of the cathode cup. Alternatively, or in addition, a profile or shape of the channel under the filament emitter may be altered. For example, the bottom surface of the channel may have a concave or curved boat-like profile. In certain embodiments, the bottom surface of the channel may have a funnel-like opening. These examples are only some of the possible examples for altering the geometry of the channel.

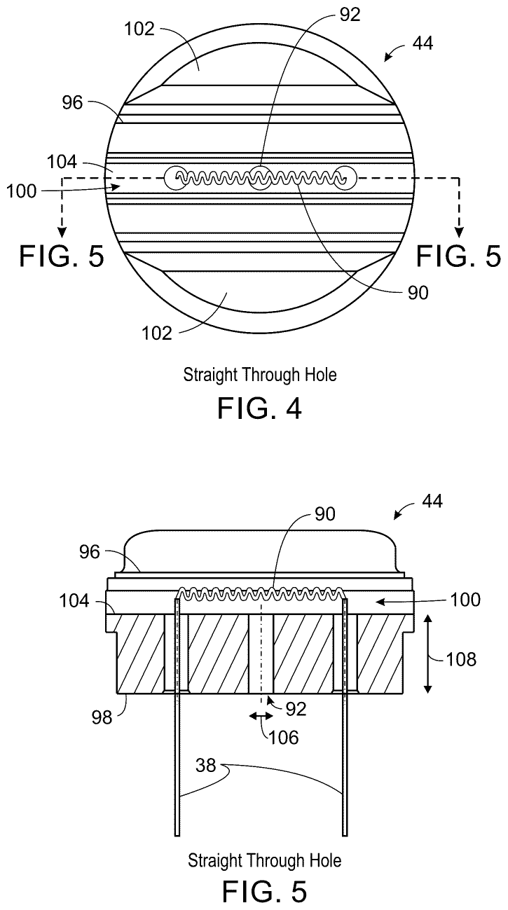

FIGS. 4 and 5 depict views of the cathode cup 44 with a single coil filament emitter 90 (coupled to electrical leads 38) having a single straight through hole 92 (e.g., having a circular shape) in a channel 100. The single straight through hole 92 affects temperature distribution on the coil filament emitter 90 for controlling anode impact temperature (without compromising the focal spot size). The cathode cup 44 includes a body 94 having a top surface 96 and a backside 98. The coil filament emitter 90 is disposed within the channel 100 (e.g., receptacle) on the top surface 96. Electrodes 102 (e.g., configured for focusing the electrons) flank the channel 100. As depicted, the straight through hole 92 extends from a bottom surface 104 of the channel 100 and all the way through the backside 98 of the body 94 of the cathode cup 44. The straight through hole 92 has a constant diameter 106 along its depth 108 (e.g., height). In certain embodiments, the diameter 106 may vary along the depth 108. As depicted, the straight through hole 92 is aligned with the center turns of the coil filament emitter 90. In certain embodiments, a location of the straight through hole 92 may vary from this central location along a longitudinal length of the channel 100. In certain embodiments, the number of holes, types of holes, and shape of holes may vary from that depicted in FIGS. 4 and 5. As depicted, the bottom surface 104 of the channel 100 is generally flat. In certain embodiments, the bottom surface 104 may not be flat (e.g., concave or curved or some other non-flat shape).

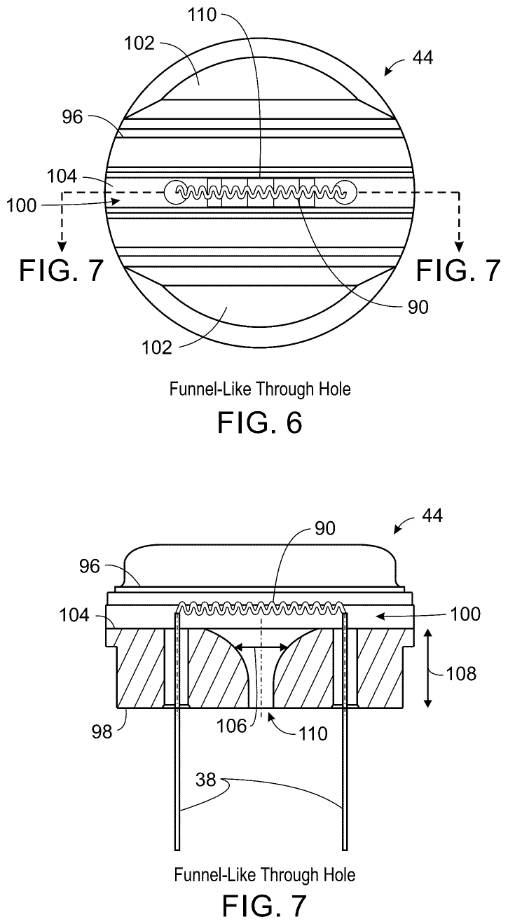

FIGS. 6 and 7 depict views of the cathode cup 44 with the single coil filament emitter 90 (coupled to electrical leads 38) having a single funnel-like through hole 110 in the channel 100. The single funnel-like through hole 110 affects temperature distribution on the coil filament emitter 90 for controlling anode impact temperature (without compromising the focal spot size). The cathode cup 44 includes a body 94 having the top surface 96 and the backside 98. The coil filament emitter 90 is disposed within the channel 100 (e.g., receptacle) on the top surface 96. Electrodes 102 (e.g., configured for focusing the electrons) flank the channel 100. As depicted, the funnel-like through hole 110 extends from the bottom surface 104 of the channel 100 and all the way through the backside 98 of the body 94 of the cathode cup 44. The funnel-like through hole 110 has the diameter 106 decrease along its depth 108 (e.g., height) from the bottom surface 104 of the channel 100 to the backside 98 of the body 94. In certain embodiments, the of the funnel-like through hole 110 may be inverted so that the diameter 106 increases along its depth 108 (e.g., height) from the bottom surface 104 of the channel 100 to the backside 98 of the body 94 As depicted, the funnel-like through hole 110 is aligned with the center turns of the coil filament emitter 90. In certain embodiments, a location of the funnel-like through hole 110 may vary from this central location along the longitudinal length of the channel 100. In certain embodiments, the number of holes, types of holes, and shape of holes may vary from that depicted in FIGS. 6 and 7.

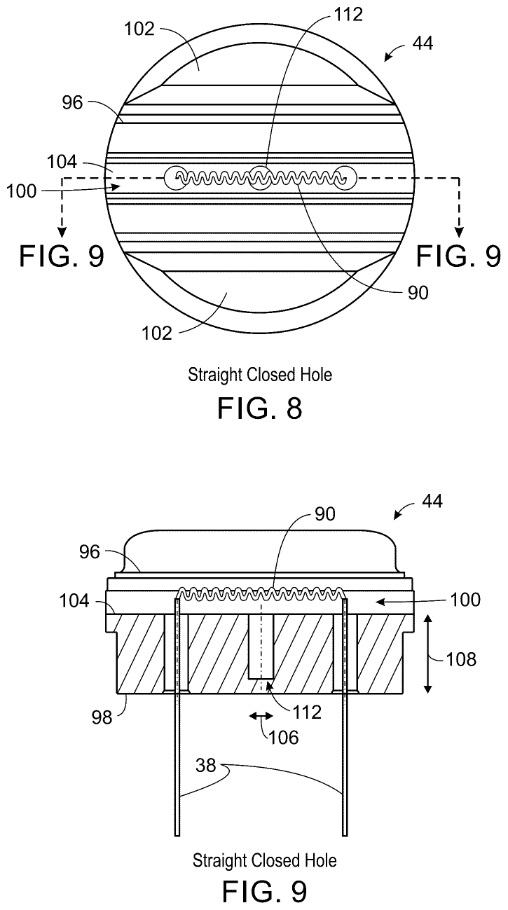

FIGS. 8 and 9 depict views of the cathode cup 44 with the single coil filament emitter 90 (coupled to electrical leads 38) having a single closed hole 112 (e.g., having a circular shape) in the channel 100. The single closed hole 112 affects temperature distribution on the coil filament emitter 90 for controlling anode impact temperature (without compromising the focal spot size). The cathode cup 44 includes the body 94 having the top surface 96 and the backside 98. The coil filament emitter 90 is disposed within the channel 100 (e.g., receptacle) on the top surface 96. Electrodes 102 (e.g., configured for focusing the electrons) flank the channel 100. As depicted, the closed hole 112 extends from the bottom surface 104 of the channel 100 toward the backside 98 of the body 94 of the cathode cup 44. However, the closed hole 112 does not extend through the backside 98 of the body 94 of the cathode cup 44. The closed hole 112 has a constant diameter 106 along its depth 108 (e.g., height). In certain embodiments, the diameter 106 may vary along the depth 108. As depicted, the closed hole 112 is aligned with the center turns of the coil filament emitter 90. In certain embodiments, a location of the closed hole 112 may vary from this central location along a longitudinal length of the channel 100. In certain embodiments, the number of holes, types of holes, and shape of holes may vary from that depicted in FIGS. 8 and 9. As depicted, the bottom surface 104 of the channel 100 is generally flat. In certain embodiments, the bottom surface 104 may not be flat (e.g., concave or curved or some other non-flat shape).

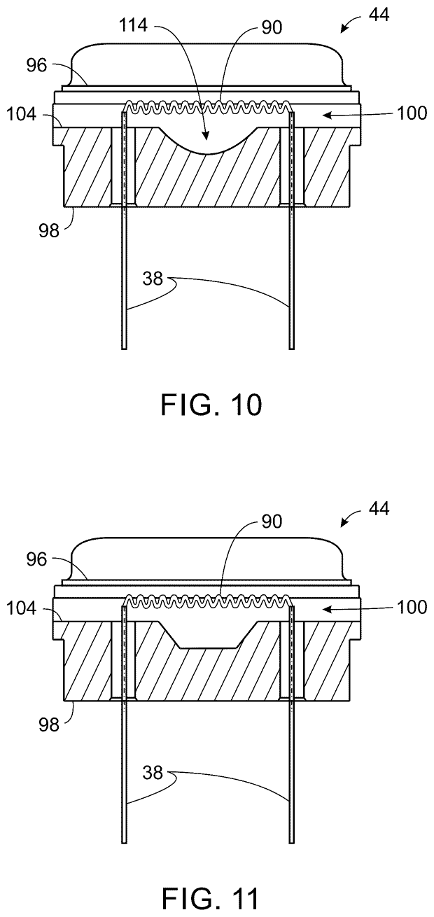

As noted above, instead of or in addition the holes, a profile or a shape of the channel 100 may be modified to alter the emitter temperature distribution. FIG. 10 depicts a side cross-sectional view of the cathode cup 44 with the single coil filament emitter 90 (coupled to electrical leads 38) having a concave recess 114 in the bottom surface 104 of the channel 100. FIG. 11 depicts a side cross-sectional view of the cathode cup 44 with the single coil filament emitter 90 (coupled to electrical leads 38) having a ramp-like recess 114 in the bottom surface 104 of the channel 100. The shape or profile of the bottom surface 104 of the channel 100 may vary from that depicted in FIGS. 10 and 11 to alter the emitter temperature distribution.

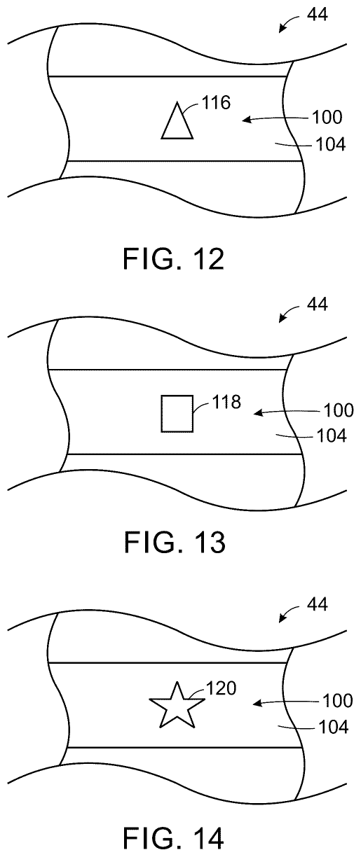

As noted above, the shape of the holes in the channel 100 of the cathode cup 44 may vary. FIG. 12 is a schematic top view of the channel 100 (e.g., the bottom surface 104 of the channel 100) of the cathode cup 44 having a hole 116 with triangular shape. FIG. 13 is a schematic top view of the channel 100 (e.g., the bottom surface 104 of the channel 100) of the cathode cup 44 having a hole 118 with square shape. FIG. 14 is a schematic top view of the channel 100 (e.g., the bottom surface 104 of the channel 100) of the cathode cup 44 having a hole 120 with star shape. The holes in channel 100 may be of any shape (e.g., elliptical, rectilinear, etc.). The holes 116, 118, and 120 affect temperature distribution on the coil filament emitter 90 for controlling anode impact temperature (without compromising the focal spot size).

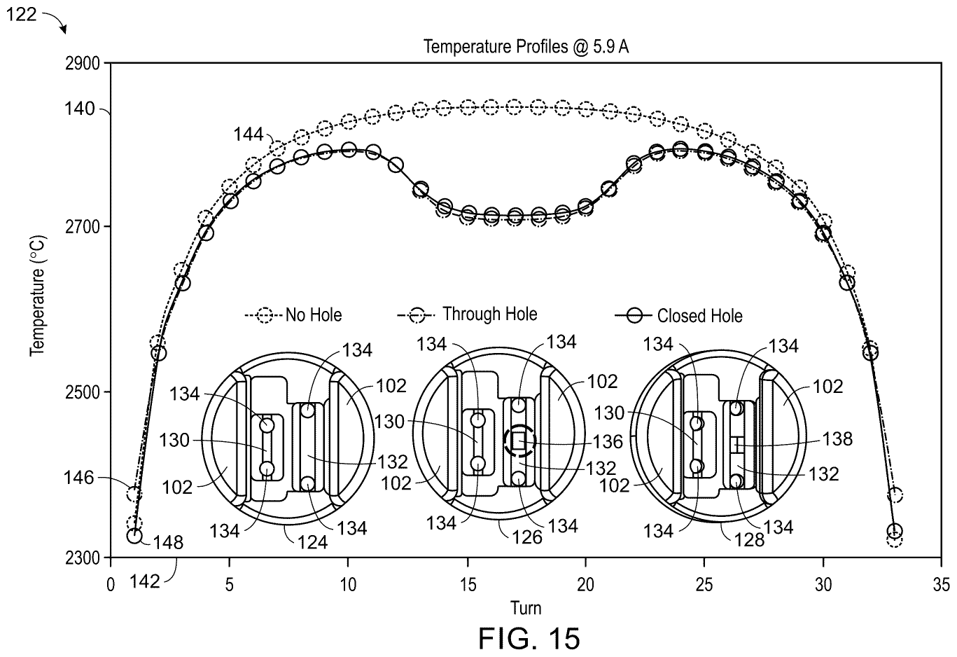

FIG. 15 depicts a graph 122 of thermo-electric simulation results of cathode cups 44 with different geometries. Top views of the respective top surface 96 of the cathode cups 44 with the different geometries are overlaid on the graph 122. The depicted cathode cups 44 (cathode cups 124, 126, 128) each includes the body 94 having a first channel 130 (e.g., shorter channel or receptacle for receiving a shorter coil filament emitter for generating a smaller focal spot) and a second channel 132 (e.g., longer channel or receptacle for receiving a longer coil filament for generating a larger focal spot). Electrodes 102 (e.g., configured for focusing the electrons) flank both the first channel 130 and the second channel 132. Each channel 130, 132 includes a pair of holes 134 for the electrical leads to couple to the respective coil filament emitter.

The cathode cup 124 lacks a hole in either channel 130, 132 that affects temperature distribution on a respective coil filament emitter for controlling anode impact temperature. The cathode cup 126 has a through hole 136 (e.g., having a square shape and centrally located) in the second channel 132 that affects temperature distribution its associated coil filament emitter for controlling anode impact temperature (without compromising the focal spot size). The through hole 136 has a depth of 2.5 millimeters (mm). The cathode cup 128 has a closed hole 138 (e.g., having a square shape and centrally located) in the second channel 132 that affects temperature distribution its associated coil filament emitter for controlling anode impact temperature (without compromising the focal spot size). The closed hole 138 has a depth of 2.4 mm. In certain embodiments, only the first channel 130 includes one or more holes that affect temperature distribution its associated coil filament emitter for controlling anode impact temperature. In certain embodiments, both the first channel 130 and the second channel 132 include one or more holes that affect the respective temperature distribution of their respective coil filament emitters for controlling anode impact temperature.

The graph 122 includes a y-axis 140 representing temperature and an x-axis 142 representing the turn in the coil filament emitter in the second channel 132. Plot 144 represents the temperature profile (at 5.9 amperes (A)) for the cathode cup 124 lacking a hole. Plot 146 represents the temperature profile for the cathode cup 126 having the through hole 136. Plot 148 represents the temperature profile for the cathode cup 128 having the closed hole 138. As depicted in the graph, the removal of material (e.g., due to the through hole 136 or the closed hole 138) in the second channel 132 results in a decrease in temperature in the region (i.e., turns) adjacent the removal of material.

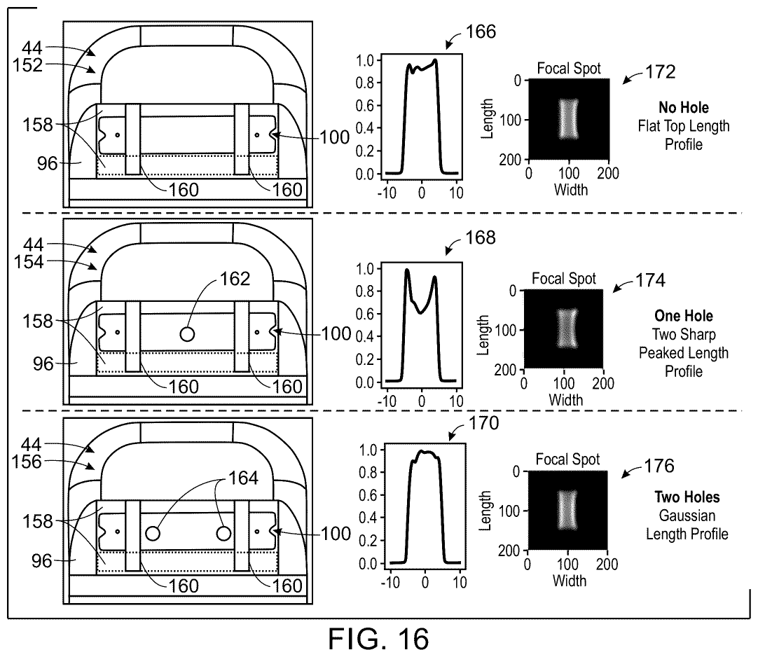

FIG. 16 is a schematic diagram of cathode cups 44 (e.g., top views of top surface 96) with different geometries that utilize flat filament emitters and associated simulated focal spot length profiles. The respective cathode cups 44 (e.g., cathode cups 150, 152, 154) include the body 94 having the top surface 96 and a backside (not shown). A flat filament emitter 156 is disposed within the channel 100 (e.g., receptacle) on the top surface 96. Septa 158 flank the channel 100 and the flat filament emitter. A pair of cathode tabs 160 transverse opposite ends of the channel 100. Adjustment of a spacing between the pair of cathode tabs 160 affects the focusing of the electron beam and focal spot length (e.g., reducing the spacing between the cathode tabs 160 reduces the focal spot length).

The cathode cup 150 lacks a hole for affecting temperature distribution on the flat filament emitter 156 for controlling anode impact temperature (without compromising the focal spot size). The cathode cup 152 has a single hole 162 (e.g., having a circular shape) in the channel 100 underneath the flat filament emitter 156 (between the pair of cathode tabs 160) for affecting temperature distribution on the flat filament emitter 156 for controlling anode impact temperature. As depicted, the hole 162 is aligned with the center of the flat filament emitter 156. In certain embodiments, a location of the hole 162 may vary from this central location along a longitudinal length of the channel 100. In certain embodiments, the number of holes, types of holes (e.g., through hole, closed hole), and shape of holes may vary from that depicted in FIG. 16.

The cathode cup 154 has a pair of holes 164 (e.g., having circular shapes) in the channel 100 underneath the flat filament emitter 156 (between the pair of cathode tabs 160) for affecting temperature distribution on the flat filament emitter 156 for controlling anode impact temperature (without compromising the focal spot size). As depicted, the pair of holes 164 are respectively disposed closer to the ends of the channel 100 (as opposed to centrally located) and the cathode tabs 160. In certain embodiments, a location of the pairs of holes 164 may vary these locations along a longitudinal length of the channel 100. In certain embodiments, the number of holes, types of holes (e.g., through hole, closed hole), and shape of holes may vary from that depicted in FIG. 16.

Graphs 166, 168, 170 depict a size and normalized intensity of a respective focal spot for each cathode cup 44 and a corresponding image 172, 174, 176 of the focal spot. Each graph 166, 168, 170 includes a y-axis representing normalized intensity and an x-axis representing size of a focal spot. Each image 172, 174, 176 of the focal spots includes an x-axis representing length and a y-axis representing width. Graph 166 and image 172 are associated with the cathode cup 150 lacking a hole for affecting temperature distribution on the flat filament emitter 156 for controlling anode impact temperature. Graph 166 and image 172 depicts a flat top length profile. The cathode cup 150 is associated with a focal spot length 1.31 mm and impact temperature of 1132° C. at 72 kilowatts (kW). Graph 168 and image 174 are associated with the cathode cup 152 having the single hole 162 for affecting temperature distribution on the flat filament emitter 156 for controlling anode impact temperature. Graph 168 and image 174 depicts a two sharp peaked length profile. The cathode cup 152 is associated with a focal spot length 1.32 mm and impact temperature of 991° C. at 72 kilowatts (kW). Graph 170 and image 176 are associated with the cathode cup 154 having the pair of holes 164 for affecting temperature distribution on the flat filament emitter 156 for controlling anode impact temperature. Graph 170 and image 176 depicts a Gaussian length profile.

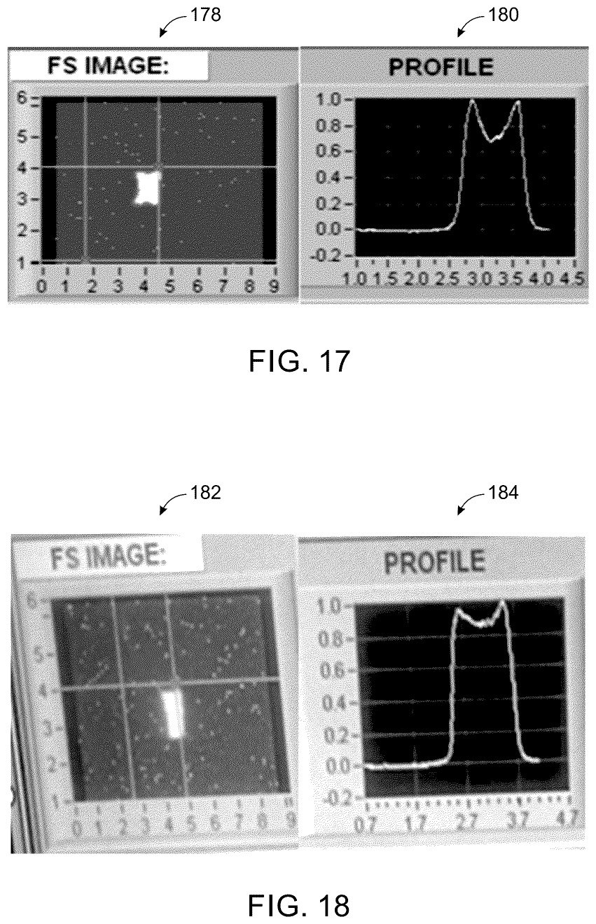

FIG. 17 depicts a measured focal spot length profile for the cathode cup 152 in FIG. 16 having the single hole 162 in the channel 100. The measured focal spot length profile includes an image 178 of the focal spot (including an x-axis representing length and a y-axis representing width) and a graph 180 depicting a size and normalized intensity of the focal spot (including a y-axis representing normalized intensity and an x-axis representing size of a focal spot). FIG. 18 depicts a measured focal spot length profile for the cathode cup 150 in FIG. 16 lacking a hole in the channel 100. The measured focal spot length profile includes an image 182 of the focal spot (including an x-axis representing length and a y-axis representing width) and a graph 184 depicting a size and normalized intensity of the focal spot (including a y-axis representing normalized intensity and an x-axis representing size of a focal spot). The measured focal spot length profiles for the cathode cups 152, 150 are similar to the simulated focal spot length profiles in FIG. 16.

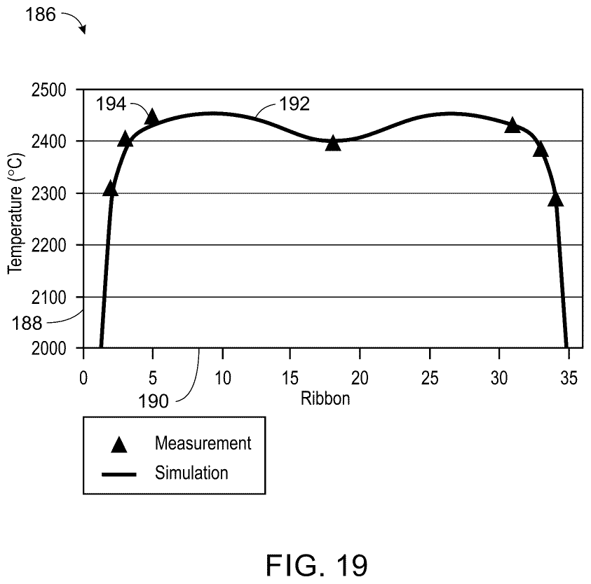

FIG. 19 depicts a graph 186 of a temperature profile of a flat coil emitter of the cathode cup 152 having the single hole 162 in the channel 100 comparing measured and simulated measurements. The graph 186 includes a y-axis 188 representing temperature and an x-axis 190 representing ribbon of the flat coil emitter. Plot 192 represents the simulation. Plot 194 represents actual measurements. The simulations match the measurements in the graph 186.

Technical effects of the disclosed embodiments include providing a cathode controlled anode impact temperature. In particular, a modified geometry in a channel of a cathode cup (e.g., cathode focusing cup) enables a reduction in target impact temperature (i.e., temperature of a target track within a focal spot resulting from impacting electrons of the electron beam) without comprising spatial resolution, enhancing the defect margin and thereby improving the yield of the X-ray tubes. When the impact temperature is minimized, without altering the focal spot size, the modified geometry can be leveraged to run the X-ray tube with smaller focal spots. Alternatively, the modified geometry can be leveraged to operate the X-ray tubes at higher powers. Technical effects of the disclosed embodiments include, without any change in the initial calibration verification, improving the manufacturing yield of the X-ray tubes, providing higher X-ray tube power capability, improving spatial resolution, and improving cost of reworking (e.g., labor hours, scrap, overheads, etc.).

The disclosure also provides support for an X-ray tube, comprising: an anode configured to rotate during operation of the X-ray tube; and a cathode assembly, comprising: a filament emitter configured to emit electrons when heated; and a cathode cup configured to focus the electrons emitted form a focal spot on an annular target track on the anode during rotation of the anode, wherein the cathode cup comprises a channel that the filament emitter is disposed within, and wherein the channel has a geometry configured to enable selective radiation to escape from the cathode cup to control a temperature profile of the filament emitter to alter a length profile of the focal spot to reduce a target impact temperature on the annular target track within the focal spot without altering a size of the focal spot. In a first example of the X-ray tube, the channel comprises at least one hole. In a second example of the X-ray tube, optionally including the first example, the at least one hole comprises a through hole. In a third example of the X-ray tube, optionally including one or both of the first and second examples, the at least one hole comprises a closed hole. In a fourth example of the X-ray tube, optionally including one or more or each of the first through third examples, the at least one hole varies in a diameter along a depth of the at least one hole. In a fifth example of the X-ray tube, optionally including one or more or each of the first through fourth examples, the at least one hole has a consistent diameter along a depth of the at least one hole. In a sixth example of the X-ray tube, optionally including one or more or each of the first through fifth examples, the channel comprises a plurality of holes. In a seventh example of the X-ray tube, optionally including one or more or each of the first through sixth examples, wherein the geometry of the channel has a curved boat-like shape. In an eighth example of the X-ray tube, optionally including one or more or each of the first through seventh examples, the filament emitter comprises a coil filament. In a ninth example of the X-ray tube, optionally including one or more or each of the first through eighth examples, wherein the filament emitter comprises a flat filament. In a tenth example of the X-ray tube, optionally including one or more or each of the first through ninth examples, the cathode assembly comprises: a first filament emitter; and a second filament emitter; and wherein the cathode cup comprises a first channel that the first filament emitter is disposed within and a second channel that the second filament emitter is disposed within, and wherein at least one of either the first channel or the second channel has the geometry configured to enable selective radiation to escape from the cathode cup to control the temperature profile of a respective filament emitter to alter the length profile of the focal spot to reduce the target impact temperature on the annular target track within the focal spot without altering the size of the focal spot. In an eleventh example of the X-ray tube, optionally including one or more or each of the first through tenth examples, both the first channel and the second channel has a respective geometry configured to enable selective radiation to escape from the cathode cup to control a respective temperature profile of the first filament emitter and the second filament emitter, respectively, to alter a respective length profile of a respective focal spot to reduce the target impact temperature on the annular target track within the respective focal spot without altering the size of the respective focal spot. In a twelfth example of the X-ray tube, optionally including one or more or each of the first through eleventh examples, the first channel and the second channel each comprise a hole. In a thirteenth example of the X-ray tube, optionally including one or more or each of the first through twelfth examples, the at least one hole has an elliptical or rectilinear shape.

The disclosure also provides support for an X-ray imaging system, comprising: an X-ray tube configured to emit X-rays, wherein the X-ray tube comprises: an anode configured to rotate during operation of the X-ray tube; and a cathode assembly, comprising: a filament emitter configured to emit electrons when heated; and a cathode cup configured to focus the electrons emitted to form a focal spot on an annular target track on the anode during rotation of the anode, wherein the cathode cup comprises a channel that the filament emitter is disposed within, and wherein the channel has a geometry configured to enable selective radiation to escape from the cathode cup to control a temperature profile of the filament emitter to alter a length profile of the focal spot to reduce a target impact temperature on the annular target track within the focal spot without altering a size of the focal spot; and an X-ray detector facing the X-ray tube and configured to generate signals in response to X-rays incident on the X-ray detector. In a first example of the X-ray imaging system, the channel comprises at least one hole. In a second example of the X-ray imaging system, optionally including the first example, the at least one hole comprises a through hole. In a third example of the X-ray imaging system, optionally including one or both of the first and second examples, the at least one hole comprises a closed hole.

The disclosure also provides support for cathode cup of an X-ray tube configured to focus electrons emitted from a filament emitter, when heated, to form a focal spot on an annular target track on an anode during rotation of the anode, comprising: a body; and a channel formed within the body, wherein the channel is configured to receive the filament emitter within, and wherein the channel comprises at least one hole configured to enable selective radiation to escape from the cathode cup to control a temperature profile of the filament emitter to alter a length profile of the focal spot to reduce a target impact temperature on the annular target track within the focal spot without altering a size of the focal spot. In a first example of the cathode cup, the at least one hole comprises a through hole or a closed hole.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

This written description uses examples to disclose the subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An X-ray tube, comprising:
an anode configured to rotate during operation of the X-ray tube; and
a cathode assembly, including:
a filament emitter configured to emit electrons when heated; and
a cathode cup configured to focus the electrons emitted form a focal spot on an annular target track on the anode during rotation of the anode, wherein the cathode cup includes a channel that the filament emitter is disposed within, and wherein the channel has a geometry configured to enable selective radiation to escape from the cathode cup to control a temperature profile of the filament emitter to alter a length profile of the focal spot to reduce a target impact temperature on the annular target track within the focal spot without altering a size of the focal spot.

2. The X-ray tube of claim 1, wherein the channel includes at least one hole.

3. The X-ray tube of claim 2, wherein the at least one hole includes a through hole.

4. The X-ray tube of claim 2, wherein the at least one hole includes a closed hole.

5. The X-ray tube of claim 2, wherein the at least one hole varies in a diameter along a depth of the at least one hole.

6. The X-ray tube of claim 2, wherein the at least one hole has a consistent diameter along a depth of the at least one hole.

7. The X-ray tube of claim 2, wherein the channel includes a plurality of holes.

8. The X-ray tube of claim 2, wherein the geometry of the channel has a curved boat-like shape.

9. The X-ray tube of claim 1, wherein the filament emitter includes a coil filament.

10. The X-ray tube of claim 1, wherein the filament emitter includes a flat filament.

11. The X-ray tube of claim 1, wherein the cathode assembly comprises:
a first filament emitter; and
a second filament emitter; and
wherein the cathode cup includes a first channel that the first filament emitter is disposed within and a second channel that the second filament emitter is disposed within, and wherein at least one of either the first channel or the second channel has the geometry configured to enable selective radiation to escape from the cathode cup to control the temperature profile of a respective filament emitter to alter the length profile of the focal spot to reduce the target impact temperature on the annular target track within the focal spot without altering the size of the focal spot.

12. The X-ray tube of claim 11, wherein both the first channel and the second channel has a respective geometry configured to enable selective radiation to escape from the cathode cup to control a respective temperature profile of the first filament emitter and the second filament emitter, respectively, to alter a respective length profile of a respective focal spot to reduce the target impact temperature on the annular target track within the respective focal spot without altering the size of the respective focal spot.

13. The X-ray tube of claim 12, wherein the first channel and the second channel each include a hole.

14. The X-ray tube of claim 1, wherein the at least one hole has an elliptical or rectilinear shape.

15. An X-ray imaging system, comprising:
an X-ray tube configured to emit X-rays, wherein the X-ray tube includes:
an anode configured to rotate during operation of the X-ray tube; and
a cathode assembly, including:
a filament emitter configured to emit electrons when heated; and
a cathode cup configured to focus the electrons emitted to form a focal spot on an annular target track on the anode during rotation of the anode, wherein the cathode cup includes a channel that the filament emitter is disposed within, and wherein the channel has a geometry configured to enable selective radiation to escape from the cathode cup to control a temperature profile of the filament emitter to alter a length profile of the focal spot to reduce a target impact temperature on the annular target track within the focal spot without altering a size of the focal spot; and
an X-ray detector facing the X-ray tube and configured to generate signals in response to X-rays incident on the X-ray detector.

16. The X-ray imaging system of claim 14, wherein the channel includes at least one hole.

17. The X-ray imaging system of claim 16, wherein the at least one hole includes a through hole.

18. The X-ray imaging system of claim 16, wherein the at least one hole includes a closed hole.

19. A cathode cup of an X-ray tube configured to focus electrons emitted from a filament emitter, when heated, to form a focal spot on an annular target track on an anode during rotation of the anode, comprising:
a body; and
a channel formed within the body, wherein the channel is configured to receive the filament emitter within, and wherein the channel includes at least one hole configured to enable selective radiation to escape from the cathode cup to control a temperature profile of the filament emitter to alter a length profile of the focal spot to reduce a target impact temperature on the annular target track within the focal spot without altering a size of the focal spot.

20. The cathode cup of claim 19, wherein the at least one hole includes a through hole or a closed hole.
